(19) United States
(12) Patent Application Publication
(10) Pub. No.: US 2026/0347656 A1
(43) Pub. Date: Nov. 5, 2026

(54) ABRASIVE PARTICLES INCLUDING PH SENSITIVE POLYMER AND SLURRY COMPOSITION INCLUDING THE SAME, FOR CHEMICAL MECHANICAL POLISHING

(71) Applicant: Samsung Electronics Co., Ltd., Suwon-si (KR)

(72) Inventor: Sanghwa LEE, Suwon-si (KR)

(73) Assignee: Samsung Electronics Co., Ltd., Suwon-si (KR)

(21) Appl. No.: 19/563,601

(22) Filed: Mar. 11, 2026

(30) Foreign Application Priority Data
May 2, 2025 (KR) 10-2025-0058545

(51) Int. Cl. C09G 1/02; C09K 3/14

(52) U.S. Cl. CPC C09G 1/02; C09K 3/1436

(57) ABSTRACT

A slurry composition for chemical mechanical polishing may include a solvent and abrasive particles dispersed in the solvent. The abrasive particles may include a core particle and a first coating part on a surface of the core particle. The core particle may include a metal oxide. The first coating part may include a pH sensitive polymer.

### CROSS-REFERENCE TO RELATED APPLICATIONS

This application claims priority under 35 U.S.C. § 119 to Korean Patent Application No. 10-2025-0058545, filed on May 2, 2025 in the Korean Intellectual Property Office, the closures of which is incorporated by reference herein in its entirety.

### BACKGROUND

Embodiments of the present disclosure described herein relate to abrasive particles used for a chemical mechanical polishing process and/or a slurry composition including the same.

A semiconductor device may be manufactured through various processes. For example, the semiconductor device may be manufactured using a photolithography process, an etching process, an ion implanting process, a polishing process, and a depositing process. The polishing process may be a process for polishing a substrate, a layer formed on the substrate, or a structure formed on the substrate to planarize the surface of the substrate. After the polishing process is performed, a residue may be present on the polishing pad and/or the surface of the substrate. To remove the residue, a cleaning process for the polishing pad and/or the substrate may be performed.

Meanwhile, as the degree of integration of a semiconductor device increases, a cleaning process may be required in a more advanced level.

### SUMMARY

Embodiments of the present disclosure provide abrasive particles and/or slurry composition having high cleaning efficiency in a chemical mechanical polishing process.

Embodiments of the present disclosure provide abrasive particles and/or a slurry composition, capable of reducing cross-contamination of a substrate caused by residues from the slurry composition during a cleaning process.

According to an embodiment of the present disclosure, a slurry composition for chemical mechanical polishing may include a solvent and abrasive particles dispersed in the solvent. Each of the abrasive particles may include a core particle and a first coating part on a surface of the core particle. The core particle may include a metal oxide. The first coating part include a pH sensitive polymer. The pH sensitive polymer may be swollen or de-swollen depending on a change in pH of the slurry composition.

According to an embodiment of the present disclosure, a slurry composition for chemical mechanical polishing may include a solvent and abrasive particles dispersed in the solvent. Each of the abrasive particles may include a core particle and a first coating part on a surface of the core particle. The core particle may include a metal oxide. The first coating part may include a pH sensitive polymer. The pH sensitive polymer may have an acidic functional group or a basic functional group.

According to an embodiment of the present disclosure, an abrasive particle may include a core particle, and a first coating part on a surface of the core particle. The core particle may include silica (SiO₂), ceria (CeO₂), zirconia ZrO₂), alumina (Al₂O₃), or a combination thereof, and the first coating part may include a pH sensitive polymer.

According to an embodiment of the present disclosure, a method for manufacturing a semiconductor device may include loading a substrate on a polishing pad, polishing the substrate by supplying a slurry composition for chemical mechanical polishing, and cleaning the substrate. The slurry composition for chemical mechanical polishing may include abrasive particles and a solvent in which the abrasive particles are dispersed. Each of the abrasive particles may include a core particle including a metal oxide and a first coating part on the surface of the core particle. The first coating part may include a pH sensitive polymer.

According to an embodiment, the cleaning of the substrate may further include supplying deionized water on a surface of the substrate.

According to an embodiment, the cleaning of the substrate may further include removing the slurry composition for chemical mechanical polishing, which remains on the substrate using a brush, after supplying the deionized water.

According to an embodiment, the supplying of the deionized water on the surface of the substrate may include swelling the first coating part and separating the abrasive particles from the surface of the substrate.

According to an embodiment, the removing of the slurry composition for chemical mechanical polishing, which remains on the substrate using the brush may include removing the abrasive particles including the first coating part swollen through the brush.

According to an embodiment, the swelling of the first coating part may further include: protonating the pH sensitive polymer by increasing pH of the slurry composition for chemical mechanical polishing to be higher than pKₐ of the pH sensitive polymer, and negatively charging the pH sensitive polymer such that electrostatic attraction is made in the pH sensitive polymer.

According to an embodiment, the pH of the slurry composition for chemical mechanical polishing may be lower than pKₐ of the pH sensitive polymer, before performing a cleaning process for the substrate.

According to an embodiment, the swelling of the first coating part may further include protonating the pH sensitive polymer by decreasing pH of the slurry composition for chemical mechanical polishing to be lower than pKₐ of the pH sensitive polymer, and positively charging the pH sensitive polymer such that electrostatic attraction is made in the pH sensitive polymer.

According to an embodiment, the pH of the slurry composition for chemical mechanical polishing may be lower than pKₐ of the pH sensitive polymer.

According to an embodiment, the pH sensitive polymer may include an acidic functional group or a basic functional group. The pH sensitive polymer including the acidic functional group may include polyacrylic acid (PAA), poly(methacrylic acid (PMAA)), polylactic acid (PLA), poly(ethylene glycol)-polyacrylic acid copolymer (PEG-PAA), or a combination of the above materials., and the pH sensitive polymer including the basic functional group may include poly(ethyleneimide (PEI)), (poly(lyline)), poly(allylamine hydrochloride) (PAH), poly(2-dimethylaminoethyl methacrylate) (PDMAEMA), or a combination of the above materials.

### BRIEF DESCRIPTION OF THE FIGURES

The above and other objects and features of the present disclosure will become apparent by describing in detail embodiments thereof with reference to the accompanying drawings.

FIG. 1 is a cross-sectional view illustrating abrasive particles according to an embodiment of the present disclosure.

FIG. 2 is a cross-sectional view illustrating abrasive particles swollen and de-swollen according to an embodiment of the present disclosure.

FIG. 3 is a cross-sectional view illustrating abrasive particles, according to an embodiment of the present disclosure.

FIG. 4 is a cross-sectional view illustrating abrasive particles swollen and de-swollen, according to an embodiment of the present disclosure.

FIG. 5 is a cross-sectional view illustrating an operation for performing a chemical mechanical polishing process using a slurry composition for chemical mechanical polishing according to an embodiment of the present disclosure.

FIG. 6 is an enlarged view illustrating region X of FIG. 5.

FIG. 7 is a cross-sectional view illustrating an operation for cleaning a substrate after performing a chemical mechanical polishing process by using a slurry composition for chemical mechanical polishing according to an embodiment of the present disclosure.

FIG. 8 is an enlarged view illustrating region X of FIG. 7.

FIG. 9 is a cross-sectional view illustrating an operation for cleaning a substrate after performing a chemical mechanical polishing process by using a slurry composition for chemical mechanical polishing according to an embodiment of the present disclosure.

FIG. 10 is an enlarged view illustrating region X of FIG. 9.

### DETAILED DESCRIPTION

Hereinafter, embodiments of the present disclosure will be described in more detail with reference to accompanying drawings.

A chemical mechanical polishing (CMP) process may be used for planarization when manufacturing a semiconductor. In the chemical mechanical polishing process, mechanical processing, which is performed by abrasive particles existing between a target to be polished and a polishing pad of a chemical mechanical polishing apparatus, and chemical etching, which is performed by the slurry composition, may simultaneously be performed. In other words, the chemical mechanical polishing process may be a process for chemically changing the surface of the target to be polished by an acidic or basic solution to instantaneously form a weak-bonded layer on the surface, and then mechanically removing the formed layer using abrasive particles. In this case, the abrasive particles may be supplied onto the surface of the target (for example, the substrate) to be polished while pressing the target to be polished, thereby mechanically polishing the surface of the target to be polished using the abrasive particles.

The present disclosure relates to a slurry composition used to perform chemical mechanical polishing for various films used in a semiconductor manufacturing process. The slurry composition for chemical mechanical polishing used in the semiconductor manufacturing process may include a slurry composition for an insulating film or a slurry composition for a metal film. According to an embodiment of the present disclosure, the slurry composition for the insulating film may be used to polish an oxide film (e.g., a silicon oxide film) in a semiconductor manufacturing process, to polish the surface of a silicon substrate after forming a trench, and/or to polish an interlayer insulating film such as a gate insulating film. The slurry composition for the metal film may be used to polish wiring, electrodes, via/contact, and/or barrier metals, in the semiconductor manufacturing process. Alternatively, the slurry composition may be used to polish a film, such as a polysilicon film, other than the insulating film or the metal film.

Hereinafter, the abrasive particles used in the slurry composition for chemical mechanical polishing will be described first, and then the slurry composition for chemical mechanical polishing, which includes the abrasive particles, will be described later.

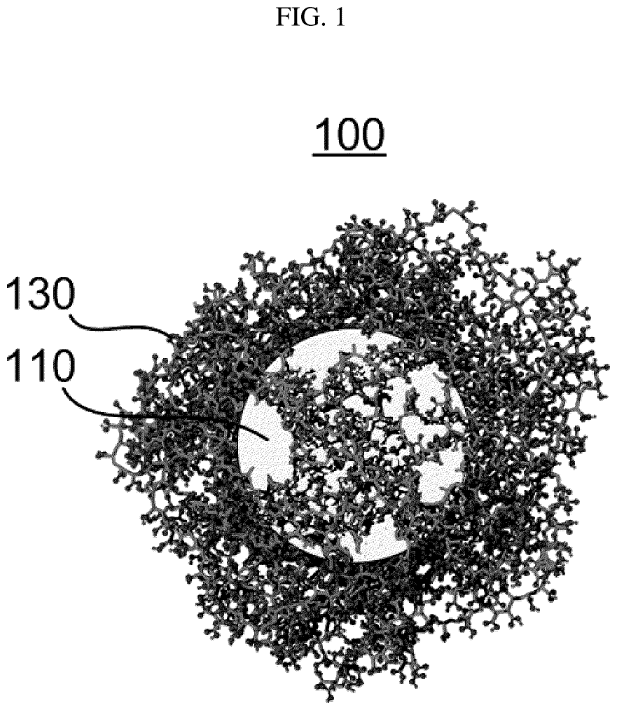

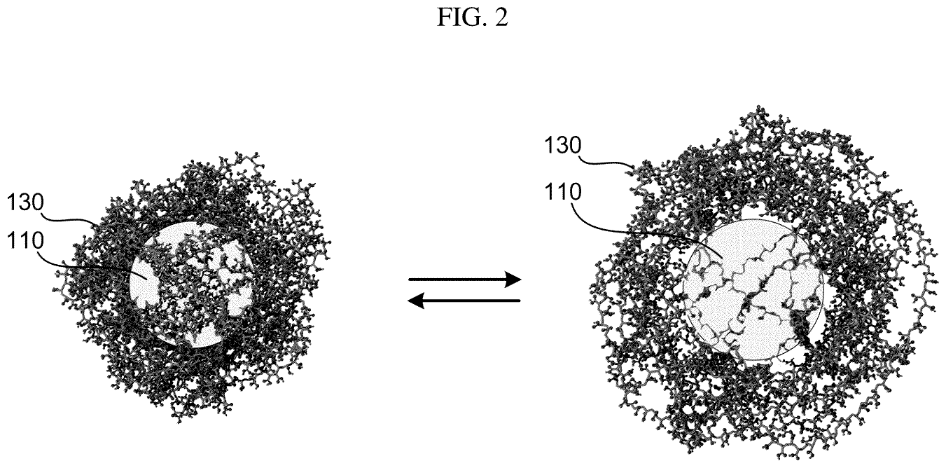

FIG. 1 is a cross-sectional view illustrating abrasive particles, according to an embodiment of the present disclosure, and FIG. 2 is a cross-sectional view illustrating abrasive particles swollen and de-swollen, according to an embodiment of the present disclosure.

Referring to FIGS. 1 and 2, an abrasive particle 100 may include a core particle 110 and a first coating part 130. The core particle 110 forms a main body of the abrasive particle 100 and may be a spherical particle including a metal oxide.

More specifically, the abrasive particle 100 may be a primary abrasive particle used in the slurry composition for chemical mechanical polishing (CMP). The primary abrasive particle may remove an irregular protrusion on a wafer surface in a process for planarizing a semiconductor device or may selectively polish the insulating film or the metal film to planarize the surface of the insulating film or the metal film.

According to an embodiment, the core particle 110 may include an inorganic oxide. The inorganic oxide may be, for example, a metal oxide. For example, the core particle 110 may include silica (SiO₂), zirconia (ZrO₂), ceria (CeO₂), alumina (Al₂O₃), or a combination thereof. However, a material constituting the core particle 110 is not limited thereto. For example, the core particle 110 may include a metal oxide such as an oxide including Fe, Al, La, Mn, Zn, Ca, Mg, Sr, Co, Ru, Os, Rh, Ir, Ni, Pd, Pt, Cu, Ag, or Au. In addition, according to an embodiment, the core particle 110 may have at least one composite oxide. In some embodiments, the core particle 110 may include an oxide of at least one of Fe, Al, La, Mn, Zn, Ca, Mg, Sr, Co, Ru, Os, Rh, Ir, Ni, Pd, Pt, Cu, Ag, or Au

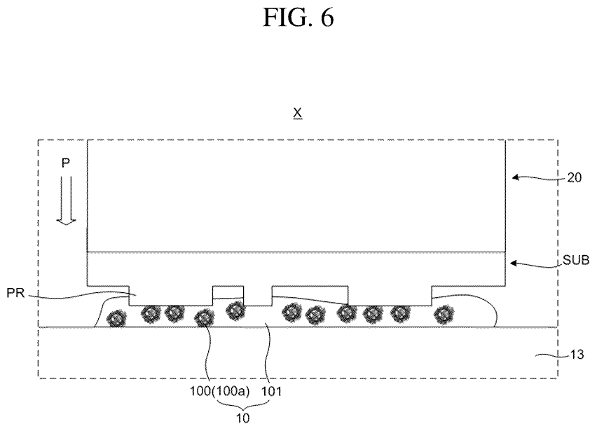

According to an embodiment, when the ceria (CeO₂) constitutes the core particle 110, the selectivity for removing a specific material of a target to be polished may be increased. For example, when the ceria (CeO₂) particles form the core particle 110, the ceria (CeO₂) particles may be present in an ionized form (for example, in the state of Ce³⁺) in a slurry composition 10 (see FIG. 6) for chemical mechanical polishing. As the reaction rate of Ce³⁺ with Si—O-increases, a larger amount of Ce—O—Si bonds may be formed. Accordingly, the polishing rate for the silicon-oxide insulating film may be increased. Silica (SiO₂) may also perform the same function as that of ceria (CeO₂).

The first coating part 130 may be provided on the surface of the core particle 110. The first coating part 130 may surround the core particle 110. According to an embodiment, the first coating part 130 and the core particle 110 may be bonded to each other.

For example, the first coating part 130 and the core particle 110 may be bonded to each other through electrostatic attraction. More specifically, when a polymer or molecular body constituting the first coating part 130 has a specific charge, the polymer or the molecular body interacts with electric charges present on the surface of the core particle 110. Accordingly, the polymer or the molecular body may be physically adsorbed to each other to be bonded to each other.

Such electrostatic bonding may be strengthened by an attractive force based on a difference in zeta potential. In other words, when the core particle 110 and the first coating part 130 have different zeta potentials, electrical double-layers are formed therebetween, thereby forming a spontaneous bond therebetween.

The first coating part 130 and the core particle 110 may be bonded through a chemical manner. For example, the first coating part 130 and the core particle 110 may be bonded through a covalent bond.

According to an embodiment, the first coating part 130 may include a pH sensitive polymer. The pH sensitive polymer may be a polymer having a structure and a volume that varies depending on a change in the pH of an external environment, and may be formed in the form of a micelle structure or a brush structure formed on the surface of the core particle 110. Accordingly, the size of the first coating part 130 may be varied depending on a change in the pH of the external environment,.

According to an embodiment, the pH sensitive polymer may have an acidic functional group. In other words, the pH sensitive polymer may be polyacid. For example, the pH sensitive polymer may include a carboxyl group (—COOH), a sulfonic acidic group (—SO₃H), a phosphoric acidic group (—PO₃H), or a combination thereof.

According to an embodiment, the pH sensitive polymer may have a pKₐ ranging from 3.5 to 6.5.

For example, the pH sensitive polymer may include polyacrylic acid; (PAA), poly(methacrylic acid (PMAA)), polylactic acid (PLA), poly(ethylene glycol)-polyacrylic acid copolymer (PEG-PAA), or a combination thereof.

Alternatively, the pH sensitive polymer may have a basic functional group. In other words, the pH sensitive polymer may be a polybase. For example, the pH sensitive polymer may include an amine group (—NH₂), an imidazole group, a pyridine group, or a combination thereof.

According to an embodiment, the pH sensitive polymer may have a pKₐ ranging from 7.5 to 9.5.

For example, the pH sensitive polymer may include poly(ethyleneimide (PEI)), poly(lysin) (poly(lyline)), poly(allylamine hydrochloride) (PAH), poly(2-dimethylaminoethyl methacrylate) (PDMAEMA), or a combination thereof.

According to an embodiment, the first coating part 130 may be swollen and/or de-swollen depending on the change in pH. For example, as illustrated in FIG. 2, when the pH sensitive polymer has an acidic functional group, in other words, when the pH sensitive polymer is polyacid, the acidic functional group may be deprotonated under an environment having the pH higher than pKₐ of the pH sensitive polymer. For example, the acidic functional group may be deprotonated under the environment having the pH higher than pKₐ of the pH sensitive polymer. In this case, the acidic functional groups of the pH sensitive polymer in the first coating part 130 may be negatively charged. In other words, the first coating part 130 may be negatively charged. Accordingly, an electrostatic repulsion may act between the acidic functional groups of the pH sensitive polymer of the first coating part 130. The first coating part 130 may be swollen by the electrostatic repulsion. Such swollen phenomenon may induce spatial expansion of the pH sensitive polymer chain, thereby causing an increase in the overall diameter of the abrasive particle 100.

In addition, the acidic functional group may be protonated under an environment having the pH lower than pKₐ of the pH sensitive polymer. For example, the acidic functional group may be protonated under the environment having the pH lower than pKₐ of the pH sensitive polymer. In this case, the acidic functional groups of the pH sensitive polymer of the first coating part 130 may electrically exhibit neutrality. In other words, the first coating part 130 may electrically exhibit neutrality. Accordingly, an electrostatic repulsion may not act between the acidic functional groups of the pH sensitive polymer of the first coating part 130. Since the electrostatic repulsion does not act to the first coating part 130, the first coating part 130 may be de-swollen, as compared to the case that the electrostatic repulsion acts.

Alternatively, when the pH sensitive polymer has a basic functional group, in other words, when the pH sensitive polymer is a polybase, the basic functional group may be protonated under an environment having the pH lower than the pKₐ of the pH sensitive polymer. In this case, the basic functional groups of the pH sensitive polymer of the first coating part 130 may be positively charged. In other words, the first coating part 130 may be positively charged. Accordingly, an electrostatic repulsion may act between the basic functional groups of the pH sensitive polymer of the first coating part 130. The first coating part 130 may be swollen by the electrostatic repulsion. Such a swollen phenomenon may induce spatial expansion of the pH sensitive polymer chain, thereby causing an increase in the overall diameter of the abrasive particle 100.

In addition, the basic functional group may be deprotonated under the environment having the pH higher than that of the pKₐ of the pH sensitive polymer. In this case, the basic functional groups of the pH sensitive polymer of the first coating part 130 may be electrically neutral. In other words, the first coating part 130 may exhibit electrically neutrality. Accordingly, an electrostatic repulsion may act between the basic functional groups of the pH sensitive polymer of the first coating part 130. Since the electrostatic repulsion does not act to the first coating part 130, the first coating part 130 is de-swollen, as compared to the case that the electrostatic repulsion acts.

According to an embodiment of the present disclosure, the abrasive particle 100 may include the first coating part 130 including the pH sensitive polymer configured to change in size depending on the pH of the external environment. Accordingly, process efficiency may be improved in the polishing process and the subsequent cleaning process.

More specifically, the abrasive particle 100 may include a pH sensitive polymer including an acidic functional group, and the pH sensitive polymer including the acidic functional group may be generally de-swollen under an acidic environment (for example, a condition having pH lower than pKₐ). Accordingly, when a chemical mechanical polishing process, such as a copper (Cu) polishing process, is performed under an acidic pH environment, the pH sensitive polymer may be de-swollen, the diameter of the abrasive particle 100 may be decreased. Therefore, as the contact area for the surface to be polished is concentrated, the higher polishing efficiency may be realized.

Therefore, a cleaning solution having higher pH, such as deionized water (DI water), may be supplied, during the cleaning process performed after the polishing process is completed. Accordingly, the pH sensitive polymer may be de-protonated and swollen under the environment a pH condition higher than that of pKₐ of the pH sensitive polymer. Accordingly, the diameter of the abrasive particle 100 may be increased, when compared to the diameter of the abrasive particle 100 in the polishing process. Accordingly, the abrasive particle 100, which remains on the substrate or the polishing pad after the polishing process, may be easily removed physically. Accordingly, cleaning efficiency may be improved.

The effect may also be exhibited even when the abrasive particle 100 includes the pH sensitive polymer including the basic functional group. For example, when a chemical mechanical polishing process, such as a tungsten (W) polishing process, under a basic pH environment is performed, the pH sensitive polymer including the basic functional group may be de-swollen. Thereafter, a cleaning solution, such as deionized water (DI water), having a lower pH is supplied during the cleaning process performed after the polishing process is completed. Accordingly, pH is lowered, when compared to the pH under the environment for the polishing process. Accordingly, the pH sensitive polymer including the basic functional group may be swollen and the size of the abrasive particle 100 may be increased.

Accordingly, the abrasive particle 100 according to an embodiment of the present disclosure includes the first coating part 130 including the pH sensitive polymer, thereby ensuring polishing efficiency during the polishing process and easy cleaning during the cleaning process.

Hereinafter, another example of the abrasive particle according to an embodiment of the present disclosure will be described.

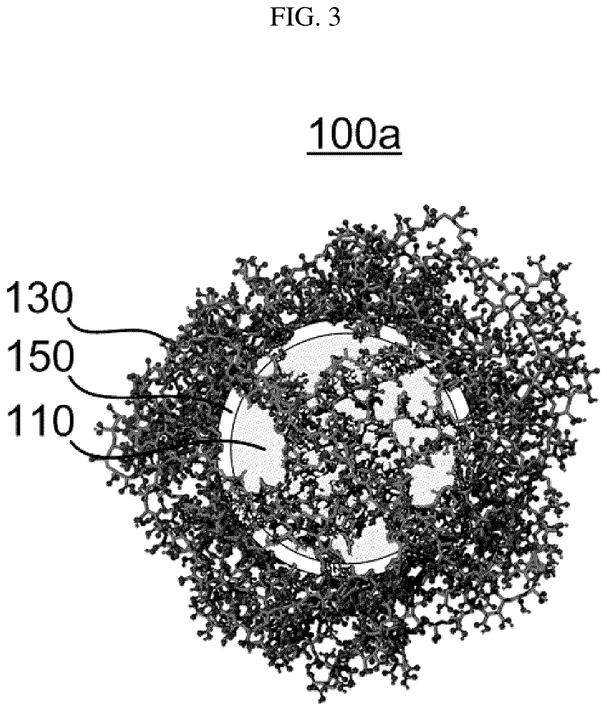

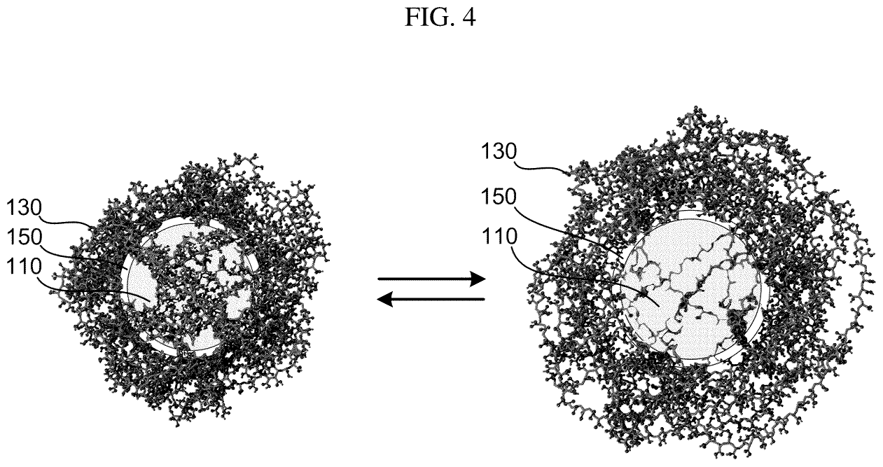

FIG. 3 is a cross-sectional view illustrating abrasive particles, according to an embodiment of the present disclosure, and FIG. 4 is a cross-sectional view illustrating abrasive particles swollen and de-swollen, according to an embodiment of the present disclosure. The following description will be described while focusing on the difference with the above-described embodiments, for the convenience of explanation.

Referring to FIGS. 3 and 4, an abrasive particle 100a may further include a second coating part 150. The second coating part 150 may be present on the surface of the core particle 110. For example, the second coating part 150 may surround the surface of the core particle 110. The second coating part 150 may be interposed between the first coating part 130 and the core particle 110.

According to an embodiment, the second coating part 150 may be bonded to the pH sensitive polymer of the first coating part 130 through a covalent bond. Alternatively, the second coating part 150 may be bonded to the core particle 110 through a covalent bond.

The second coating part 150 may include an organic functional group to bond the first coating part 130 to the core particle 110. The second coating part 150 may be connected to the core particle 110 to constitute a surface-modified inorganic oxide particle.

More specifically, the abrasive particle 100a may include the surface-modified inorganic oxide. In this case, the surface-modified inorganic oxide may be an inorganic oxide having a surface modified with an organic material. In other words, the second coating part 150 may be a part formed by modifying the surface of the core particle 110. For example, the second coating part 150 may be a layer formed by modifying the surface of the core particle 110.

The surface modification may be performed through a coupling reaction using polymer graft on the surface of the inorganic oxide. For example, the surface-modified inorganic oxide may be prepared by coupling a hydroxyl functional group (—OH) present on the surface of the inorganic oxide to a prepolymer having a reactive terminal group with the hydroxyl functional group. In this case, the terminal group which reacts with the above hydroxyl group include, for example, an isocyanate group (—NCO), a trialkoxysilyl group (—Si(OR)₃), and a chlorosilyl group (—SiCl₃).

However, the surface modification is not limited thereto, and the second coating part 150 may be formed through various methods. For example, a radical polymerization reaction may be performed on the surface of the core particle 110 to form the second coating part 150. For example, the second coating part 150 may include a cationic monomer and/or polymer, anionic monomer and/or polymer, a nonionic monomer and/or polymer, or a combination thereof.

The second coating part 150 formed by modifying the surface of the hydroxyl functional group of the core particle 110 may serve as an intermediate layer for mediating a chemical bond between the core particle 110 and the first coating part 130.

Meanwhile, a method for manufacturing abrasive particles according to an embodiment of the present disclosure will be described below.

According to an embodiment, the abrasive particles 100 may be manufactured with various materials through various manners. In the following description, the abrasive particle 100 of FIG. 1 is manufactured through the physical bond by way of example.

First, a dispersion solution including the core particles 110 may be prepared. The core particles 110 may include ceria (CeO₂), silica (SiO₂), alumina (AL₂O₃), or a combination thereof. In this case, ultrasonic dispersion or mechanical stirring may be performed such that the core particles 110 may be uniformly dispersed in the aqueous solution. In this case, the pH of the dispersion solution may be adjusted, based on the charge on the surface of the core particle 110.

Next, a solution including the pH sensitive polymer is added to the dispersion and mixed for a specific period of time. In this process, the pH sensitive polymer may be adsorbed into the surface of the core particle 110 through the physical interaction of electrostatic attraction or a hydrogen bond. Specifically, the physical bonding between the core particle 110 and the pH sensitive polymer may be induced due to a difference in zeta potential or a charge distribution complementary to each other between the core particle 110 and the pH sensitive polymer. Accordingly, the first coating part 130 including the pH sensitive polymer may be formed on the surface of the core particle 110.

After the mixing is completed, the mixture is cleaned and dried to prepare the abrasive particle 100 in a form in which the first coating part 130 is physically bonded to the surface of the core particle 110. Thereafter, if necessary, post-treatment processes, such as filtration, centrifugation, deionized water cleaning, and drying under reduced pressure, may be performed on the mixture.

According to an embodiment, the abrasive particles 100a may be manufactured with various materials through various manners. In the following description, the abrasive particle 100a of FIG. 3 is manufactured through the chemical bond by way of example.

First, the core particle 110 may be prepared. The core particle 110 may be an inorganic oxide particle such as ceria (CeO₂), silica (SiO₂), alumina (AL₂O₃), or a combination thereof. In addition, a reactive functional group, such as a hydroxyl group (—OH), may be present on the surface of the core particle 110.

Then, the surface of the core particle 110 may be modified to form the second coating part 150. The second coating part 150 may be formed using a coupling agent or a functional precursor which may react with the reactive functional group present on the surface of the core particle 110. For example, the second coating part 150 may be formed by introducing a reactive ring or functional group (for example, an amine group (—NH₂) or carboxyl group (—COOH)) to the surface of the core particle 110 using an organosilane compound having a trialkoxysilyl group Si(OR)₃), a chlorosilyl group (—SiCl₃), or an isocyanate group (—NCO).

The first coating part 130 may be formed by introducing the pH sensitive polymer into the surface of the core particle 110 having the second coating part 150 formed thereon. In this case, a reaction may be induced to form a covalent bond between a reactive functional group introduced on the surface of the second coating part 150 and a terminal functional group of the pH sensitive polymer. For example, an amide bond formation reaction may be induced between the surface of the second coating part 150 employing an amine group (—NH₂), and the pH sensitive polymer having a carboxyl group (—COOH). The reaction may be performed under a condensation reactive coupling conditions or a chemical bonding conditions using an activator. Accordingly, the pH sensitive polymer may be fixed to the second coating part 150. Accordingly, the first coating part 130 including the pH sensitive polymer may be formed on the second coating part 150.

The core particle 110 having the pH sensitive polymer fixed thereto through the covalent bonding may be cleaned and dried to prepare the abrasive particle 100a including the second coating part 150 and the first coating part 130. Therefore, if necessary, a cleaning process to remove reaction residues, a drying process to stabilize the structure of the polymer chain, and a post-treatment process may be performed.

Meanwhile, the slurry composition including the abrasive particles for chemical mechanical polishing according to an embodiment of the present disclosure will be described below.

According to an embodiment of the present disclosure, the slurry composition for chemical mechanical polishing may include abrasive particles 100 and 100a, and a solvent in which the abrasive particles 100 and 100a are dissolved and/or dispersed. The slurry composition may include the abrasive particles 100, the abrasive particles 100a, or a combination of the abrasive particles 100 and the abrasive particles 100a.

According to an embodiment, the abrasive particles 100 and 100a may be included in an amount ranging from 0.01 wt % to 10 wt % based on the total weight of the slurry composition for chemical mechanical polishing. For example, the abrasive particles 100 and 100a may be included in an amount ranging from 0.01 wt % to 10 wt %, 0.01 wt % to 5 wt %, 0.01 wt % to 3 wt %, 0.01 wt % to 1 wt %, 0.01 wt % to 0.5 wt %, 0.01 wt % to 0.3 wt %, or 0.01 wt % to 0.1 wt %, based on the total weight of the slurry composition for chemical mechanical polishing.

When the weights of the abrasive particles 100 and 100a are greater than the above range, the possibility of flocculation of the abrasive particles 100 and 100a in the slurry composition for chemical mechanical polishing may be increased. When the abrasive particles 100 and 100a are largely aggregated, defects, such as scratches, may be formed on the target to be polished. In addition, the abrasive particles 100 and 100a may remain on the surface of the target to be polished after polishing. Accordingly, the abrasive particles 100 and 100a may act as foreign substances on the surface.

When the weights of the abrasive particles 100 and 100a are less than the above range, the polishing rate may be reduced for the target to be polished. Accordingly, the polishing efficiency may be degraded.

The solvent may include various solvents, as long as the solvent is used for the slurry composition for chemical mechanical polishing. According to an embodiment, the solvent may be deionized water or ultrapure water.

According to an embodiment, the solvent may include water (for example, or deionized water) as an aqueous carrier, and may include at least one water-miscible organic solvent. The organic solvent may include an alcohol (for example, propenyl alcohol, isopropyl alcohol, ethanol, 1-propanol, methanol, or 1-hexanol); aldehyde (for example, acetylaldehyde); ketones (for example, acetone, diacetone alcohol, or methyl ethyl ketone); esters (for example, ethyl formate, propyl formate, ethyl acetate, methyl acetate, methyl lactate, butyl lactate, or ethyl lactate); ethers including sulfoxide (for example, dimethyl sulfoxide (DMSO), tetrahydrofuran, dioxane, or diglym); amides (for example, N-dimethylformamide, dimethylimidazolidinone, or N-methylpyrrolidone); polyhydric alcohols and derivatives (for example, ethylene glycol, glycerol, diethylene glycol, or diethylene glycol monomethyl ether) of polyhydric alcohols; and/or nitrogen-containing organic compounds (for example, acetonitrile, amylamine, isopropylamine, or dimethylamine).

A weight of the solvent may be a remaining weight excluding the weight of the abrasive particles 100 and 100a from the entire weight of the slurry composition for chemical mechanical polishing. When the slurry composition for chemical mechanical polishing includes an additional additive, the solvent may be a remaining weight excluding the weight of the abrasive particles 100 and 100a and the weight the additive.

According to an embodiment, the slurry composition for chemical mechanical polishing may be provided in a colloidal type. In this case, the abrasive particles 100 and 100a may be colloidal particles. When the abrasive particles 100 and 100a are provided in a colloidal type, the abrasive particles 100 and 100a may have a zeta potential value ranging from 1 mV to 100 mV, 1 mV to 80 mv, 5 mV to 60 mv, or 10 mV to 50 mV, in the pH range from about 2 to about 12.

The abrasive particles 100 and 100a may be varied in size depending on the target to be polished or the composition of the slurry composition, but may have a diameter in a nanometer scale, for example, a diameter ranging from several to hundreds of nm. For example, the size of the abrasive particles 100 or 100a may range from 1 nm to 400 nm, from 1 nm to 200 nm, or 1 nm to 100 nm. As another example, the size of the abrasive particles 100 and 100a may range from 1 nm to 50 nm, 1 nm to 25 nm, 1 nm to 10 nm or to 1 nm to 5 nm.

When the abrasive particles 100 and 100a are larger than the above size, the flocculation of the abrasive particles 100 and 100a may be increased. In addition, the abrasive particles 100 and 100a may be adsorbed into the surface of the target to be polished and may remain. Alternatively, when the abrasive particles 100 and 100a are smaller than the above size, the polishing rate for the target to be polished may be excessively low, thereby degrading polishing efficiency.

According to an embodiment, the slurry composition for chemical mechanical polishing may further include various additives, in addition to the abrasive particles 100 and 100a and the solvent.

According to an embodiment, a pH adjusting agent may be included in the slurry composition for chemical mechanical polishing. The pH adjusting agent may allow the slurry composition for chemical mechanical polishing to have a pH ranging from about 2 to about 12. The pH adjusting agent may adjust the pH, based on the final pH, the polishing rate, and the polishing selectivity of the composition.

According to an embodiment, the slurry composition for chemical mechanical polishing may further include an acidic pH adjusting agent or a basic pH adjusting agent. For example, at least one acidic or basic pH adjusting agent and at least one buffer may be included in the pH adjusting agent. The pH adjusting agent may include a material to adjust the pH without an influence exerted on the characteristic of the slurry composition for chemical mechanical polishing.

According to an embodiment, when the first coating part 130 of the abrasive particles 100 and 100a includes the pH sensitive polymer having an acidic functional group, the slurry composition for chemical mechanical may include the acid pH adjusting agent.

For example, the acidic pH adjusting agent may include sulfuric acid, hydrochloric acid, nitric acid, phosphoric acid, acetic acid, citric acid, glutaric acid, glycolic acid, formic acid, lactic acid, malic acid, malonic acid, maleic acid, oxalic acid, phthalic acid, succinic acid, tartaric acid, or a combination thereof.

According to an embodiment, when the first coating parts 130 of the abrasive particles 100 and 100a may include pH sensitive polymers having a basic functional group, the slurry composition for chemical mechanical polishing may include the basic pH adjusting agent.

For example, the basic pH adjusting agent includes lysine, glycine, alanine, arginine, valine, leucine, isoleucine, methionine, cysteine, proline, histidine, phenylalanine, serine, threonine, tyrosine, tryptophan, aminobutyric acid, imidazole, triethanolamine, tetramethylammonium hydroxide, tetraethylammonium hydroxide, ammonium methyl propanol, ammonia, potassium hydroxide, sodium hydroxide, magnesium hydroxide, rubidium hydroxide, cesium hydroxide, sodium bicarbonate, sodium carbonate, thromethamine, niacinamide, or a combination thereof.

The amount of the pH adjusting agent may range from about 0.0001 wt % to about 5 wt % based on the total weight of the slurry composition for chemical mechanical polishing. For example, the pH adjusting agent may be provided while ranging from about 0.0005 wt % to about 1 wt %, about 0.0005 wt % to about 0.5 wt %, or about 0.001 wt % to about 0.1 wt %, based on the total weight of the slurry composition for chemical mechanical polishing.

A surfactant may be further included in the slurry composition for chemical mechanical polishing. The surfactant may include a cationic surfactant, an anionic surfactant, an anionic polymer electrolyte, a nonionic surfactant, an amphoteric surfactant, a fluorinated surfactant, and/or mixtures thereof. For example, the gas-phase surfactant may include a sodium dodecyl sulfate salt, sodium lauryl sulfate, an ammonium dodecyl sulfate salt, an alcohol ethoxylate, an acetylene-based surfactant, or a combination thereof.

The amount of the surfactant may be provided while ranging from about 0.0001 wt % to about 10 wt %, about 0.001 wt % to about 2 wt %, or about 0.001 wt % to about 0.1 wt %, based on the total weight of the slurry composition for chemical mechanical polishing.

The surfactant may stabilize the slurry composition for chemical mechanical polishing. The content of the surfactant may be varied depending on the characteristics of the surface of the abrasive particles 100 and 100a. When the surfactant is not sufficiently used, the slurry composition for chemical mechanical polishing may not be stabilized. In contrast, when an excessive amount of surfactant is used, unintended foaming and/or flocculation may be made in the slurry composition.

A dispersion additive may be included in the slurry composition for chemical mechanical polishing. Accordingly, the particle dispersion of the slurry composition for chemical mechanical polishing may be stabilized. For example, the dispersing additive may include organic acids and salts of the organic salts, polymer acids and salts of the polymer acids, water-soluble copolymers and salts of the water-soluble copolymers, a copolymer containing at least two different types of acidic groups, such as carboxylic, sulfonic, or phosphonic groups, within the same molecule, and salts of the acidic groups, polyvinyl acid and salts of polyvinyl acid, polyethylene oxide, polypropylene oxide, or a combination thereof.

For example, the polymer acid may include polyacrylic acid, poly-methacrylic acid, polystyrene sulfonic acid, and/or a salt thereof. The number average molecular mass (Mn) of the polymer may range from about 1,000 to about 1,000,000, from about 2,000 to about 100,000, or from about 10,000 to about 50,000.

The amount of the dispersion additive may be about 0.0010 wt % to about 1.0 wt %, or about 0.005 wt % to about 0.5 wt % or about 0.01 wt % to about 0.25 wt %, based on the total weight of the slurry composition for chemical mechanical polishing.

An oxidizing agent and an oxidizing catalyst may be included in the slurry composition for chemical mechanical polishing, depending on the target to be polished. For example, when the target to be polished is metal, the slurry composition for chemical mechanical polishing may further include an oxidizing agent, an oxidizing catalyst, and/or an igniter.

The oxidizing agent may be at least one selected from the group consisting of hydrogen peroxide, urea hydrogen peroxide, urea, percarbonate, periodic acid, periodate, perchloric acid, perchlorate, perbromic acid, perbromate, perboric acid, perborate, permanganese acid, permanganate, persulfate, bromate, chlorate, hydrochloride, chromate, iodic acid, iodic acid, ammonium peroxide, benzoyl peroxide, calcium peroxide, barium peroxide, sodium peroxide and peroxidizing elements, but the present disclosure is not limited thereto.

The oxidizing agent may be contained in an amount of 1 wt % to 10 wt %, 1 wt % to 8 wt %, or 3 wt % to 7 wt %, based on the total weight of the slurry composition for chemical mechanical polishing. When the oxidizing agent is greater than the above range, the flatness may be degraded due to excessive oxidation of the surface of the metal film. Alternatively, when the oxidizing agent is less than the above range, oxidation of the metal is too small. Accordingly, the polishing rate may be reduced.

The oxidation catalyst may be a complex of at least one selected from the group consisting of Fe, Mn, Co, Ce, Ru, Os, Rh, Ir, Ni, Pd, Pt, Cu, Ag, and Au. According to an embodiment, the oxidation catalyst may be a complex of Fe, but the present disclosure is not limited thereto. The complex may be an ammonium salt, a potassium salt, or a sodium salt having 1 to 4 carbonate, gluconate, sulfonate, or phosphate functional groups. In addition, the complex may be an ammonium salt, a potassium salt, or a sodium salt of Fe having two carbonates, but the present disclosure is not limited thereto.

The oxidation catalyst may be included in an amount of 0.01 wt % to 0.5 wt %, 0.01 wt % to 0.3 wt %, 0.01 wt % to 0.1 wt %, or 0.01 wt % to 0.05 wt %, based on the total weight of the slurry composition for chemical mechanical polishing.

An igniter may include at least one selected from the group consisting of gluconic acid, citric acid, tartaric acid, lactic acid, oxalic acid, ascorbic acid, acetic acid, sodium salt thereof, potassium salt thereof, and/or ammonium salt thereof.

Meanwhile, the method for manufacturing the semiconductor device using the slurry composition for chemical mechanical polishing according to an embodiment of the present disclosure will be described below.

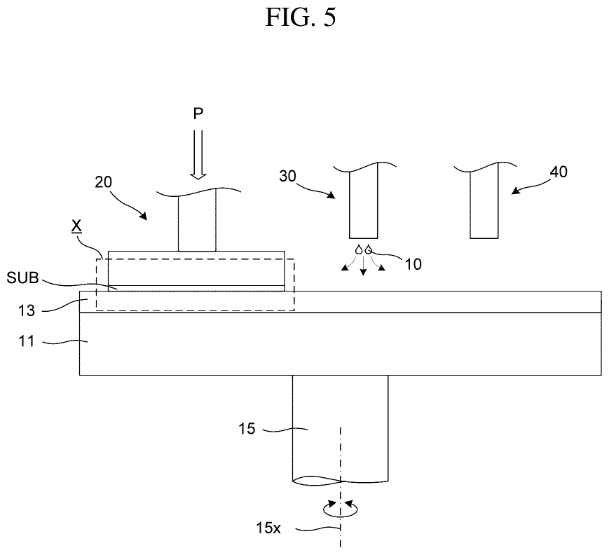

FIG. 5 is a cross-sectional view illustrating an operation for performing a chemical mechanical polishing process using a slurry composition for chemical mechanical polishing, according to an embodiment of the present disclosure, and FIG. 6 is an enlarged view illustrating region X of FIG. 5. The following description will be described while focusing on the difference with the above-described embodiments, for the convenience of explanation.

Referring to FIGS. 5 and 6, the chemical mechanical polishing apparatus according to an embodiment of the present disclosure may include a polishing pad 13, a platen 11 to support the polishing pad 13, a driving spindle 15 to rotate the platen 11, a polishing module 20 to place a substrate SUB on the polishing pad 13 to polish the polishing pad 13, and a first supply device 30 and a second supply device 40 to supply a polishing slurry 10.

First, the polishing module 20 may hold the substrate SUB to load the substrate SUB onto a top surface of the polishing pad 13.

In this case, the substrate SUB may include, for example, a substrate after the chemical mechanical polishing process, or a substrate including at least one layer and/or a structure after the chemical mechanical polishing process. The substrate and the substrate including the at least one layer and/or structure may be used through the manufacturing process of the semiconductor device. In this case, the substrate SUB may include a semiconductor substrate including a semiconductor material, a silicon-on-insulator (SOI) substrate, a metal substrate, a glass substrate, and a plastic substrate. The semiconductor substrate may include, for example, a silicon substrate, a germanium substrate, a silicon-germanium substrate, or other suitable semiconductor material. In addition, the substrate SUB may include at least one of an organic film, an inorganic film, an organic/inorganic composite film, or a metal film, which is formed on the substrate.

Thereafter, the first supply device 30 may supply the polishing slurry 10 onto the polishing pad 13. In this specification, the polishing slurry 10 may be a composition of the slurry composition for chemical mechanical polishing. The polishing slurry 10 may include abrasive particles 100 and 100a and a solvent 101. The first supply device 30 may include a conduit (e.g., pipe) for supplying the slurry.

According to an embodiment, while the polishing process is performed, the polishing slurry 10 may maintain an acidic environment or a basic environment. For example, the pH of the polishing slurry 10 may range from 2 to 4 or from 8 to 10. In this case, the abrasive particles 100 and 100a may be de-swollen.

Next, the driving spindle 15 rotates about a rotational axis 15x to rotate the platen 11 and the polishing pad 13. As the polishing pad 13 rotates, the polishing slurry 10 may be spread on the surface of the polishing pad. As illustrated in FIG. 6, the polishing module 20 may bring the substrate SUB into the surface of the polishing pad 13, thereby performing the polishing process for the substrate SUB.

More specifically, in the state in which the polishing slurry 10 is provided between the substrate SUB and the polishing pad 13, the polishing module 20 may perform a rotational motion and a vibration motion, and the polishing pad 13 may perform a rotational motion to polish the substrate SUB. For example, the polishing module 20 (e.g., substrate holder) may press the substrate SUB toward the polishing pad 13 under constant pressure P.

In addition, the surface of the substrate SUB and the polishing pad 13 may make contact with each other by a load of the polishing module 20 and applied pressure, and the polishing slurry 10 may flow between contact surfaces. Accordingly, a mechanical removal action may be performed by the abrasive particle 100 in the polishing slurry 10. Simultaneously, a chemical removal action may be performed on the surface of the substrate SUB by the chemical components in the polishing slurry 10.

For example, when roughness exists on the surface of the substrate SUB as illustrated in FIG. 6, contact with the abrasive particle 100 may be made from a protrusion PR. In this case, pressure may be concentrated on the protrusion PR and may have a higher surface removal speed than other portions. The protrusion PR may be uniformly removed over the entire area while the processing is performed. Through the above-described process, the polishing of the substrate SUB may be completed.

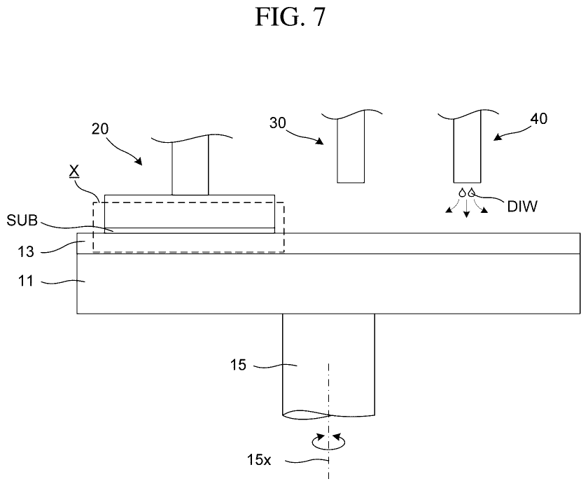

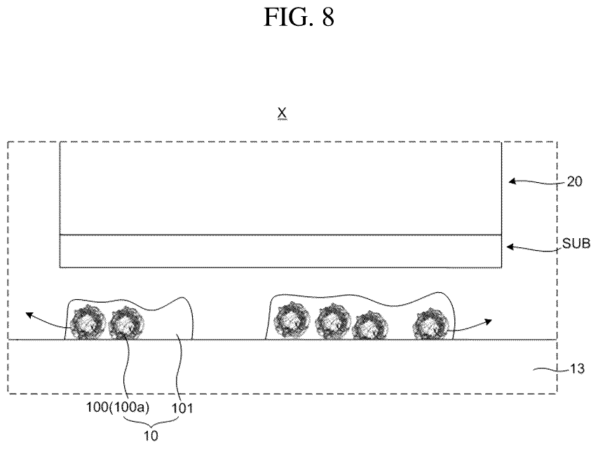

FIG. 7 is a cross-sectional view illustrating an operation for cleaning a substrate after performing a chemical mechanical polishing process by using a slurry composition for chemical mechanical polishing, according to an embodiment of the present disclosure, and FIG. 8 is an enlarged view illustrating region X of FIG. 7;

Referring to FIGS. 7 and 8, after polishing the substrate SUB, a portion of the polishing slurry 10 may remain on the surface of the substrate SUB and/or the top surface of the polishing pad 13.

Thereafter, a cleaning process may be performed for the substrate SUB. In this case, the second supply device 40 (e.g., conduit) may spray deionized water DIW onto the surface of the polishing pad 13. The deionized water DIW may be evenly spread on the surface of the polishing pad 13 due to the rotation of the polishing pad 13. The deionized water DIW may be mixed with the polishing slurry 10 remaining between the substrate SUB and the polishing pad 13. The deionized water DIW may be mixed with the polishing slurry 10 remaining between the substrate SUB and the polishing pad 13. Due to the mixing, the pH of the polishing slurry 10 may increase or decrease, and as a result, the abrasive particles 100 and 100a may be swollen.

For example, when the polishing slurry 10 includes the abrasive particles 100 and 100a having the pH sensitive polymer having the acidic functional group, the pH of the polishing slurry 10 may be higher than the pKₐ of the pH sensitive polymer having the acidic functional group due to mixing of the deionized water DIW. Accordingly, as illustrated in FIG. 8, the abrasive particles 100 and 100a may be a swollen.

In contrast, when the polishing solution 10 includes the abrasive particles 100 and 100a having the pH sensitive polymer having the basic functional group, the pH of the polishing solution 10 may be lower than the pKₐ of the pH sensitive polymer having the basic functional group due to mixing of the deionized water DIW. Accordingly, as illustrated in FIG. 8, the abrasive particles 100 and 100a may be swollen.

As the abrasive particles 100 and 100a are swollen, the abrasive particles 100 and 100a remaining on the surface of the substrate SUB and/or the top surface of the polishing pad 13 may be easily separated. For example, as illustrated in FIG. 8, the abrasive particles 100 and 100a remaining on the polishing pad 13 may be separated from the top surface of the polishing pad 13 to the outside, as the polishing pad 13 rotates.

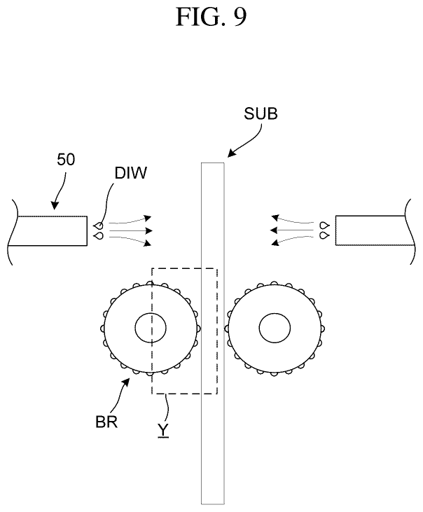

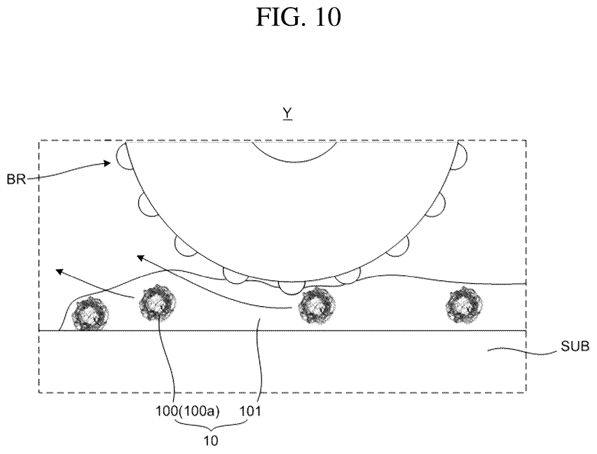

FIG. 9 is a cross-sectional view illustrating an operation for cleaning a substrate after performing a chemical mechanical polishing process by using a slurry composition for chemical mechanical polishing, according to an embodiment of the present disclosure, and FIG. 10 is an enlarged view illustrating region X of FIG. 9.

Referring to FIGS. 7 and 8, a portion of the polishing slurry 10 may remain on the surface of the substrate SUB even after the process of cleaning the substrate SUB and the polishing pad 13 by supplying the deionized water DIW. To remove the portion, which remains on the surface of the substrate SUB, an additional cleaning process may be performed on the surface of the substrate SUB using a brush BR.

More specifically, as illustrated in FIG. 8, the remaining polishing slurry 10 may be cleaned by contacting the brush BR on the surface of the substrate SUB. The brush BR may clean the substrate SUB through a rotational motion, while the third supply device 50 may simultaneously spray the deionized water DIW onto the surface of the substrate SUB.

In this case, the abrasive particles 100 and 100a may be easily swollen due to the additional mixing of the deionized water DIW. Accordingly, the abrasive particles 100 and 100a remaining on the surface of the substrate SUB may be easily separated. For example, as illustrated in FIG. 8, as the abrasive particles 100 and 100a are swollen, a probability of making contact with the brush BR may be increased. Accordingly, the abrasive particles 100 and 100a may be easily removed from the surface of the substrate SUB.

According to an embodiment of the present disclosure, the abrasive particles and the slurry composition may improve efficiency of the cleaning process.

According to an embodiment of the present disclosure, the abrasive particles and the slurry composition may reduce the cross-contamination of the substrate caused by the residue of the slurry composition during the cleaning process.

According to an embodiment of the present disclosure, a method of manufacturing a slurry composition for chemical mechanical polishing may include providing abrasive particles; and dispersing the abrasive particles in a solvent. Each of the abrasive particles may include a core particle and a first coating part on a surface of the core particle. The core particle may include a metal oxide. The first coating part may include a pH sensitive polymer, and the pH sensitive polymer may be swollen or de-swollen depending on a change in pH of the slurry composition.
In some embodiments, the core particle may include silica (SiO₂), zirconia (ZrO₂), ceria (CeO₂), alumina (Al₂O₃), or a combination thereof.
In some embodiments, the pH sensitive polymer may have an acidic functional group or a basic functional group.
In some embodiments, the pH sensitive polymer may include polyacrylic acid (PAA), poly(methacrylic acid (PMAA)), polylactic acid (PLA), poly(ethylene glycol)-polyacrylic acid copolymer (PEG-PAA), or a combination thereof, or the pH sensitive polymer may include poly(ethyleneimide (PEI)), poly(lysin)(poly(lyline)), poly(allylamine hydrochloride) (PAH), poly(2-dimethylaminoethyl methacrylate) (PDMAEMA), or a combination thereof.
In some embodiments, each of the abrasive particles may further include a second coating part. The second coating part may be between the core particle and the first coating part, and the second coating part may surround the surface of the core particle.

The technical scope of the present disclosure is not limited to the detailed description of this specification, but should be defined by the claims.

Although some example embodiments of the present disclosure have been described for illustrative purposes, those skilled in the art will appreciate that various modifications, and substitutions are possible, without departing from the scope and spirit of the invention as disclosed in the accompanying claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A slurry composition for chemical mechanical polishing, the slurry composition comprising:
a solvent; and
abrasive particles dispersed in the solvent, wherein
each of the abrasive particles includes a core particle and a first coating part on a surface of the core particle,
the core particle includes a metal oxide,
the first coating part includes a pH sensitive polymer, and
the pH sensitive polymer is swollen or de-swollen depending on a change in pH of the slurry composition.

2. The slurry composition of claim 1, wherein the core particle includes:
silica (SiO₂), zirconia (ZrO₂), ceria (CeO₂), alumina (Al₂O₃), or a combination thereof.

3. The slurry composition of claim 1, wherein the pH sensitive polymer has an acidic functional group.

4. The slurry composition of claim 3, wherein the pH sensitive polymer has pKₐ ranging from 3.5 to 6.5.

5. The slurry composition of claim 3, wherein the pH sensitive polymer includes:
polyacrylic acid (PAA), poly(methacrylic acid (PMAA)), polylactic acid (PLA), poly(ethylene glycol)-polyacrylic acid copolymer (PEG-PAA), or a combination thereof.

6. The slurry composition of claim 3, further comprising:
an acidic pH adjusting agent,
wherein the acidic pH adjusting agent include sulfuric acid, hydrochloric acid, nitric acid, phosphoric acid, acetic acid, citric acid, glutaric acid, glycolic acid, formic acid, lactic acid, malic acid, malonic acid, maleic acid, oxalic acid, phthalic acid, succinic acid, tartaric acid, or a combination thereof.

7. The slurry composition of claim 3, wherein the acidic functional group is selected among functional groups protonated under an environment in which the pH of the slurry composition for chemical mechanical polishing is lower than pKₐ of the pH sensitive polymer, and deprotonated under an environment in which the pH of the slurry composition for chemical mechanical polishing is higher than pKₐ of the pH sensitive polymer.

8. The slurry composition of claim 3,
wherein the pH sensitive polymer is able to be de-swollen under an environment in which the pH of the slurry composition for chemical mechanical polishing is lower than pKₐ of the pH sensitive polymer, and
wherein the pH sensitive polymer is able to be swollen under an environment in which the pH of the slurry composition for chemical mechanical polishing is higher than pKₐ of the pH sensitive polymer.

9. The slurry composition of claim 1, wherein the pH sensitive polymer has a basic functional group.

10. The slurry composition of claim 9, wherein the pH sensitive polymer has pKₐ ranging from 7.5 to 9.5.

11. The slurry composition of claim 9, wherein the pH sensitive polymer includes:
poly(ethyleneimide (PEI)), poly(lysin)(poly(lyline)), poly(allylamine hydrochloride) (PAH), poly(2-dimethylaminoethyl methacrylate) (PDMAEMA), or a combination thereof.

12. The slurry composition of claim 9, further comprising:
a basic pH adjusting agent,
wherein the basic pH adjusting agent includes lysine, glycine, alanine, arginine, valine, leucine, isoleucine, methionine, cysteine, proline, histidine, phenylalanine, serine, threonine, tyrosine, tryptophan, aminobutyric acid, imidazole, triethanolamine, tetramethylammonium hydroxide, tetraethylammonium hydroxide, ammonium methyl propanol, ammonia, potassium hydroxide, sodium hydroxide, magnesium hydroxide, rubidium hydroxide, cesium hydroxide, sodium bicarbonate, sodium carbonate, thromethamine, niacinamide, or a combination thereof.

13. The slurry composition of claim 9, wherein the basic functional group is selected among functional groups protonated under an environment in which the pH of the slurry composition for chemical mechanical polishing is lower than pKₐ of the pH sensitive polymer, and deprotonated under an environment in which the pH of the slurry composition for chemical mechanical polishing is higher than the pKₐ of the pH sensitive polymer.

14. The slurry composition of claim 9, wherein
the pH sensitive polymer is able to be swollen under an environment in which the pH of the slurry composition for chemical mechanical polishing is lower than pKₐ of the pH sensitive polymer, and
the pH sensitive polymer is able to be de-swollen under an environment in which the pH of the slurry composition for chemical mechanical polishing is higher than pKₐ of the pH sensitive polymer.

15. The slurry composition of claim 1, wherein the first coating part and the core particle are bonded to each other through electrostatic attraction.

16. The slurry composition of claim 1, wherein
each of the abrasive particles further includes a second coating part,
the second coating part is between the core particle and the first coating part, and
the second coating part surrounds the surface of the core particle.

17. The slurry composition of claim 16, wherein
the second coating part is bonded to the pH sensitive polymer through covalent bonding, and
the second coating part is bonded to the core particle through covalent bonding.

18. A slurry composition for chemical mechanical polishing, the slurry composition comprising:
a solvent;
abrasive particles dispersed in the solvent, wherein
each of the abrasive particles includes a core particle and a first coating part on a surface of the core particle,
the core particle includes a metal oxide,
the first coating part includes a pH sensitive polymer, and
the pH sensitive polymer has an acidic functional group or a basic functional group.

19. The slurry composition of claim 18, wherein
the pH sensitive polymer having the acidic functional group is negatively charged under an environment in which a pH of the solvent is higher than pKₐ of the pH sensitive polymer, and
the pH sensitive polymer having the basic functional group is positively charged under an environment in which the pH of the solvent is lower than the pKa of the pH sensitive polymer.

20. An abrasive particle comprising:
a core particle; and
a first coating part on a surface of the core particle, wherein
the core particle includes silica (SiO₂), ceria (CeO₂), zirconia (ZrO₂), alumina (Al₂O₃), or a combination thereof, and
the first coating part includes a pH sensitive polymer.
